(19) United States
(12) Patent Application Publication
(10) Pub. No.: US 2019/0151758 A1
(43) Pub. Date: May 23, 2019

(54) UNIQUE VIRTUAL ENTITY CREATION BASED ON REAL WORLD DATA SOURCES

(71) Applicant: International Business Machines Corporation, Armonk, NY (US)

(72) Inventors: Howard N. Anglin, Leander, TX (US); Simon D. Mikulcik, Murray, KY (US); Michael Rowden, Cedar Park, TX (US); Jillian F. Tempelmeyer, Austin, TX (US); Leigh A. Williamson, Georgetown, TX (US)

(21) Appl. No.: 15/821,463

(22) Filed: Nov. 22, 2017

(51) Int. Cl. A63F 13/52; G06F 17/30; G06N 99/00; G06N 7/00; A63F 13/30; A63F 13/65

(52) U.S. Cl. CPC A63F 13/52; G06F 17/30985; A63F 13/65; G06N 7/005; A63F 13/30; G06N 99/005

(57) ABSTRACT

A set of data associated with one or more real world conditions is received over at least one wireless network and from one or more sources. It is determined, based at least on a quantity of string instances of the set of data that match each other, that a first subset of the set of data surpasses an interest level threshold. A second subset of the set of data does not surpass the interest level threshold. At least one unique virtual entity is generated for use in a virtual environment of a virtual game based on the first subset of data surpassing the interest level threshold.

### BACKGROUND

The present disclosure relates to creating virtual entities in virtual environments using data from real world sources to populate virtual objects.

A virtual environment is generally a computer environment where graphical representations and logic are used to simulate physical structures or rules that may occur in the real world. A virtual entity is a character (e.g., a video game character), object, event, and/or instance within the virtual environment that can take aspects of itself from various bits of information existing in the real world or in cyberspace.

### SUMMARY

According to embodiments of the present disclosure, a computer-implemented method, a system, and a computer program product are disclosed. In some embodiments, the computer-implemented method includes receiving, over at least one wireless network and from one or more sources, a set of data associated with one or more real world conditions. It can be determined, based at least on a quantity of string instances of the set of data that match each other, that a first subset of the set of data surpasses an interest level threshold. A second subset of the set of data may not surpass the interest level threshold. At least one unique virtual entity can be generated for use in a virtual environment of a virtual game based on the first subset of data surpassing the interest level threshold.

In some embodiments, the system includes at least one computing device that has at least one processor and at least one computer readable storage medium having program instructions embodied therewith. The program instructions can be readable or executable by the at least one processor to cause the system to perform the following steps. A first set of social data is received from one or more sources. The first set of social data is compared to a second set of social data that was generated at a time prior to a generation of the first set of social data. A prediction is made based on patterns associated with the second set of social data that the first set of social data is associated with a first characteristic. In response to the predicting, at least one unique virtual entity for use in a virtual environment of a virtual game is generated.

In some embodiments, the computer program product includes a computer readable storage medium having program instructions embodied therewith. The program instructions can be readable or executable by a computing system to cause the computing system to perform the following steps. At least one virtual entity for use in a virtual environment of a virtual game is generated. A set of data associated with one or more characteristics of one or more users of the virtual game is received from one or more sources. The at least one unique virtual entity is modified as a background task and based on the one or more characteristics of the one or more users.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a schematic diagram depicting a computing environment for the creation of unique virtual entities within virtual environments using online data sources, according to various embodiments.

FIG. 2 is a block diagram depicting a system environment for collecting and parsing data for insertion into virtual entity objects to create unique virtual entities, according to various embodiments.

FIG. 3 is a flow diagram depicting retrieving data, populating unique virtual entities, creating unique virtual entities and modifying unique virtual entities, according to various embodiments.

FIG. 4 is a flow diagram depicting the creation and population of empty virtual entities to create unique virtual entities, according to various embodiments.

FIG. 5 is a block diagram depicting a system environment in which separate data fields of a virtual entity are populated using data from various system modules to create a unique virtual entity, according to various embodiments.

FIG. 6 is a flow diagram depicting the modification of data being passed to a virtual entity and the modification of created unique virtual entities, according to various embodiments.

FIG. 7 is a schematic diagram depicting an illustrative virtual environment, according to various embodiments.

FIG. 8 is a block diagram of a computing device, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to unique virtual entities, and more specifically to creating and modifying unique virtual entities based on collection and grouping of real world data in corresponding virtual entity objects. While the present disclosure is not necessarily limited to such applications, various aspects of the disclosure may be appreciated through a discussion of various examples using this context.

The creation of virtual entities is currently an inefficient and time consuming process requiring significant manual input by humans and a lot of computer processing power. For example, in a virtual video gaming environment generating a unique character or storyline (e.g., a plot) can require creativity and the ability to translate artistic works into computer readable formats. With existing gaming technology, character and story entities can require lengthy conceptualization by human artists, followed by rigorous modeling and attribute creation in manual 3-D computer environments by human programmers. The present disclosure recognizes that automating the process of creating unique virtual entities via various rules/learning improves the existing technology by removing inefficiencies in human artistic creation as well as eliminating costs associated with transference to a digital format. Collection and grouping of data from multiple online and offline sources will ensure that all virtual entities created during the automation process are completely unique.

The automation of the creation process of an entity via the methods described below are useful and efficient. For example, an automation process that creates unique virtual entities which are not necessarily based on objects already found in the real world would improve virtual entity creation by a computer system by reducing time and cost associated with the creative process.

The present disclosure further recognizes that it is beneficial to have unique virtual entities in a virtual environment to be constantly updated in real-time or near real-time to make the virtual environment more effective as an immersive user environment. Consequently, a system that adjusts the behavior of the entities based on a constantly changing a set of rules or chancing behavior based on learning (e.g., machine learning) represents a more immersive virtual environment than existing technology. Existing technology creates and maintains static virtual entities due to the process of manual conception of ideas by human artists and manual computer implementation via various rules through developers.

According to various embodiments, a system controlling a game environment is utilized. The game may involve the interaction of any combination of a virtual environment, a virtual character, a storyline, a player, and game logic. The virtual environment may be a human-immersive environment, involving any combination virtual world scenery, a virtual character which may be a player character, a storyline to provide a goal to a character, or game logic that simulates physical rules governing the interaction between objects in the real world or real world conditions (e.g., trending media topics, such as current weather, sales, and/or topic interest patterns that exist in the world). As disclosed herein a “storyline” refers to a plot or sequence of main elements that make up a story or narrative (e.g., a video game). For example, a storyline can include each level that makes up a video game and/or the goal(s) that must be accomplished before the game is completed or beaten. This may include meeting various policies or criteria before the game is accomplished.

According to embodiments, a game storyline may include any entity or object in a game setting, rendered or not, which contains at least some logic designed to interact with the character, track aspects of a game, and/or create interactive game logic between a character and another game entity. For example, a game storyline may be a virtual object, unseen to a player character, which tracks a character's distance vector to another object relative to the storyline object itself. The storyline object may update game logic, interact with the character, and/or create a notification upon the character object's distance vector value falling below a certain threshold compared to another location in a virtual world. The character has “reached” the location of the virtual world and has “participated” in the storyline. A game storyline can further be or include an object that exists throughout the game containing properties which are designed to interact with the character. For example, a game storyline may set tasks for a player character to accomplish from the beginning to the end of a runtime, at which point the game plot object is deleted from the game. In some embodiments, the storyline is dynamically changed based on data received from one or more sources (e.g., the source 106). For example, the number of levels in a game may be reduced or added to a current virtual environment. In another example, the number of features (e.g., graphical icons, a point level threshold) can also be added or reduced within the virtual environment.

According to embodiments, a system running a game environment queries one or more devices over a network in order to retrieve data for the creation of a unique virtual entity in the game environment. The network can include one or more server connections to the system running a game environment through a wired or wireless connection and using any suitable communications protocol standard (e.g., a Transmission Control Protocol/Internet Protocol (TCP/IP)) to convey and interpret information. According to embodiments, the system running a game environment may be a front-end user interface system connected to a back-end character creation system, or any combination thereof. In embodiments, the system connects, over the network, with one or more devices containing information obtainable to the system over the network. The system then specifies information locations on the devices and queries the network or browses the network to visit various internet nodes in an automated manner (e.g., via a tailored Application Programming Interface (API) and/or web “crawling”) to collect as much relevant data as possible.

The system may query various hosts over a network in order to search device sources known to be relating to current events and newsfeeds. As a result of the query, data is retrieved through the network in any format from any type of source relating to the query. For example, if the system queries for news feeds in a basic string format, it may retrieve, through the network, raw Extensible Markup Language (XML) data from a news aggregation site.

Once one or more devices have been queried over the network, the system may attempt to secure data and return it to the system's internal memory. The system may select which data it will retrieve from the devices through the network and in what amounts or formats that data will be received. In some embodiments, for example, a system sends a data request to a server device via a wireless connection indicating an address or a set of rules for finding addresses in cyberspace. The server device will route to the address given by the system and begin extracting raw data in the form of integers, characters, strings and/or more complex data structures and sending them back via the wireless connection to the system in sequences of integers, characters or data bits.

According to some embodiments, raw or unstructured data received by the system through the network will be parsed according to a Natural Language Processor (NLP). The NLP may follow a process while takes in raw data as strings and outputs singular strings or phrases which may be sorted according to categories or other identifiers or “mapped,” for example.

According to some further embodiments, the NLP intakes raw or unstructured data in the form of a text file containing a number of characters. The NLP separates the characters into individual words by checking for linking characters such as spaces, commas or hyphens, or “tokenizing” the data file. Additionally, the NLP may separate and store individual words as string data, separate from other strings. In some embodiments, the NLP may parse each individual “token” string against a dictionary of known words in the system and categorize the strings with a unique identifier or a category identifier, effectively “mapping” them in the system.

In one embodiment, for example, a NLP system may intake a sentence like “John ate red candy instead.” An NLP first tokenizes the raw sentence data to extract the token words “John,” “ate,” “red,” “candy,” and “instead”. An NLP parser including a part-of-speech (POS) tagger and having access to a dictionary file compares each token string to the dictionary file and determine the part of speech each word represents. Upon finding the words “ate” and “instead” are a verb and adverb respectively, the system may decide to discard those tokens. The parser will recognize “John” and “candy” as nouns and “red” as an adjective. Consequently, “red” may be placed inside a map data structure with the key value COLOR or ADJECTIVE. “John” may be further parsed and placed inside a map data structure with the key value NAME or PROPER NOUN. The token “candy” may be “mapped” with the key value OBJECT or NOUN.

In some embodiments, a semantic relationship identifier may be a part of the NLP that may identify semantic relationships and/or domains of recognized text elements (e.g., words, phrases) in documents. In some embodiments, the semantic relationship identifier may determine functional dependencies between strings or tokens and other semantic relationships. For example, when the string “red” is processed by the NLP, the semantic relationship identifier may first identify the semantic category of “red” to “BRIGHT COLOR”. The semantic relationship identifier may further generate key values for map data structures to corresponding to tokens identified.

According to embodiments, a “unique virtual entity” is an entity in a virtual environment corresponding to a character, storyline, and/or any other instance is it would appear or be displayed in the virtual environment. A unique virtual entity may be represented in the system by a class (e.g., an object-oriented programming class), an instance of a class, and/or a data structure (e.g., a hash map), each of which may be referred to herein as a “unique virtual entity object.” Each unique virtual entity object may include at least one data field relating to an attribute of the unique virtual entity. A virtual entity object that has not yet been created in the virtual environment and does not correspond to a unique virtual entity is referred to as an incomplete virtual entity object. An incomplete virtual entity object has at least one data field which corresponds to an attribute that a character, event or storyline will have in the virtual environment. Once an incomplete virtual entity object has a specified number of data fields filled, it becomes a unique virtual entity object.

According to some embodiments, the system will use the data retrieved from the NLP to populate a data field of an incomplete virtual entity object which corresponds to a character, event and/or storyline object located in memory but not yet created in the game. The system will use the category of data, possibly inside of a mapped data structure (e.g., a hash table), which was received for the NLP to match the category of a data field in a character object and populate that field with the data set. As disclosed herein, a data set is any data instance or set of data instances that is an equal or smaller portion of some larger full data set (e.g., a specified quantity of bits in a data word, a first volume of data within a two-volume disk, a data partition, the entire character sequence of a string, etc.) Once a requisite number of data fields have been populated, the incomplete virtual entity object will be reassigned by the system as a unique virtual entity object to be rendered as a unique virtual entity in a virtual environment.

According to further embodiments, an incomplete virtual entity object is created by the system such that the incomplete virtual entity object is empty, having null values corresponding to its data fields. For example, the system may create an incomplete virtual entity object representing a CHARACTER data type having several data fields corresponding to aspects of that character. In object-oriented programming, for example, such a data type would be a class and data fields would be various subclasses or parameters or variables in the class. The actual data within the data fields correspond to one or more attributes that describe or are associated with the data type class in a particular way. The CHARACTER data type may contain data fields corresponding to the attributes of the individual character. For example, a CHARACTER data structure may have a NAME, APPEARANCE, or ID NUMBER parameters that are set as null when initially created as an incomplete virtual entity object. The data fields may be categorized according to unique mapping categories that correspond with the categories found in the NLP.

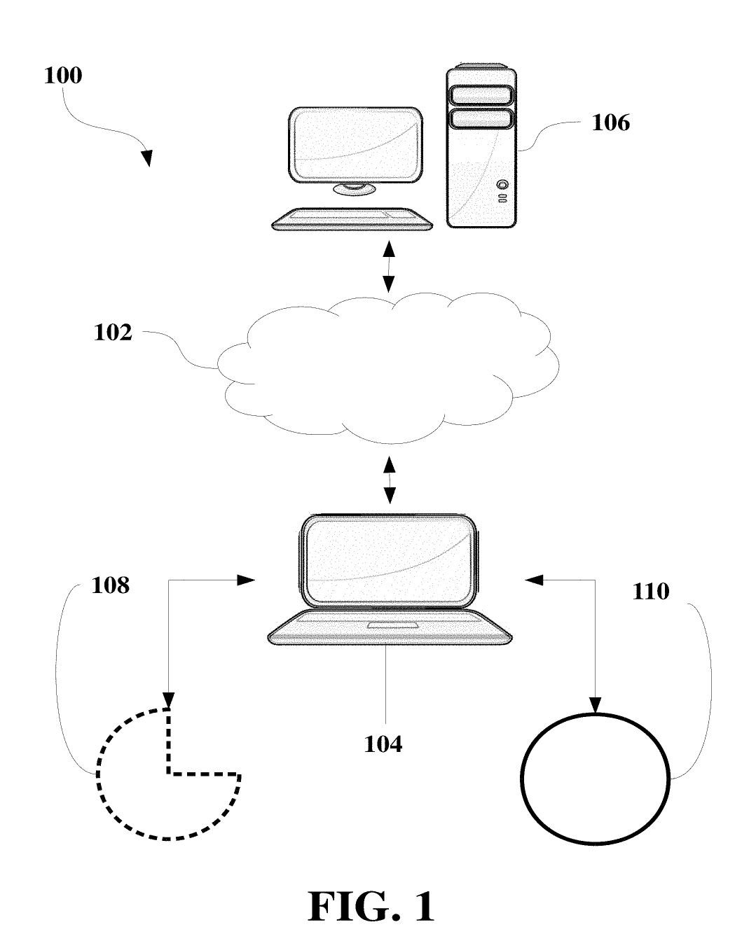

FIG. 1 is a schematic diagram depicting a computing environment 100 for the creation of unique virtual entities within virtual environments using online data sources, according to various embodiments.

The first computer system(s) 104 queries network(s) 102 connected to one or more data sources 106 (e.g., one or more web servers), seeking data that may be utilized in the creation process of a unique virtual entity. The first computer system(s) 104 may query, for example, network(s) 102 for data relating to current events or popular buzzwords on social media. Alternatively, the first computer system(s) may query, for example, the network(s) 102 for data relating to integer values corresponding to webpages that represent total viewer count or “hits” in a limited amount of time.

In some embodiments, the first computer system(s) 104 is or includes one or more user-front-end devices, one or more back-end server devices, or any combination thereof. The purpose of a user-front-end may be to perform calculations necessary to update the virtual environment. The purpose of back-end server device(s) may be to perform calculations relating to obtaining data, creating unique virtual entities and transferring data to the user-front-end device.

The computer system(s) 104 and the one or more data sources 106 communicate via the one or more networks 102. Network(s) 102 is or includes any suitable network such as a local area network (LAN), a general wide area network (WAN), a personal area network (PAN), and/or a public network (e.g., the internet).

In some embodiments, the first computing system(s) 104 (e.g., a mobile device) connects (via the network 102) to the one or more data sources 106, such as another computing system server, webpage, and/or raw data feed to directly retrieve data relevant to a query. In some embodiments, the computing system 104 interfaces with an API corresponding to the data sources 106 in order to retrieve the needed data. Once relevant data has been found, the first computing system(s) 104 retrieves the data from the separate computing system, webpage, or raw data feed and can generate unique virtual entities.

The first computing system(s) 104 may attempt to parse any data it has received over the network(s) 102 to populate the fields of an incomplete virtual entity object 108 in the system. The incomplete virtual entity object may be a class object, data structure, system file, library file or any other virtual entity object capable of being populated by data. The incomplete virtual entity object may contain at least one data field that is filled or populated with data.

The first computing system(s) 104 may determine at any time that an incomplete virtual entity object has been populated with sufficient data to finish populating the entity with data. According to various embodiments, the incomplete entity object is populated with at least two data sets from at least two distinct sources to be considered unique and therefore fit for creation in a virtual environment. For example, “distinct sources” may include a first server that hosts a first service (e.g., a social media service) and a second server that hosts a second unrelated server (e.g., a weather service). When such a threshold is met, the first computing system(s) 104 may generate and create a unique virtual entity object 110 from the previously incomplete virtual entity object 108.

According to various embodiments, sources of raw data may include online and/or offline data feeds. The system may retrieve data from postings on social media, celebrity gossip sites, newspaper services, electronic books, electronic journals, weather services, blog posts, and/or HTML website tags for example. Instead of or in addition, the system may receive data from its own internal memory or storage device, user-input, or any peripherals connected to the system that may be available offline.

According to embodiments, the system runs and maintains a data collector module which can function as a collector of raw data from sources as well as perform NLP. For example, a data connector module may be the point of entry in the system for raw data feeds which has subsequently passed through a NLP program in the data collector module to produce data sets fit for insertion into an incomplete virtual entity object.

According to some embodiments, the system runs and maintains an entity generator module, which may function as the creation mechanism for unique virtual entities and unique virtual entity objects. The entity generator module will receive the data sets produced by the data collector. The entity generator will continue to populate the data fields of an incomplete virtual entity object until it is considered a unique virtual entity object and created as a unique virtual entity in a virtual environment.

According to a further embodiment, a unique virtual entity object is a member of a subclass class specific to unique virtual entities, such as a companion character, for example. A companion character class may contain data fields in the incomplete virtual entity object corresponding to NAME, MOOD, VECTOR, and DISTANCE. Once a sufficient number of data fields have been filled, all data fields for example, the system will designate the incomplete virtual entity object as a unique virtual entity of the companion character class. A unique virtual entity corresponding to the companion character will be created in the virtual environment and all rendered aspects of the companion character will be drawn in the unique virtual environment, including data fields. For example, the companion characters MOOD, or movement VECTOR may be drawn in a virtual environment via pixels on a screen.

According to a further embodiment, the system runs and maintains an entity updater module, which has access to the created unique virtual entities and may update or modify data sets in the data fields of the corresponding unique virtual entity object(s). For example, the data fields in a unique virtual entity object may be modifiable once the corresponding unique virtual entity is created in the virtual environment. The data fields may be modifiable by an entity updater module in real time or near real time when the virtual environment is a game environment, according to various embodiments.

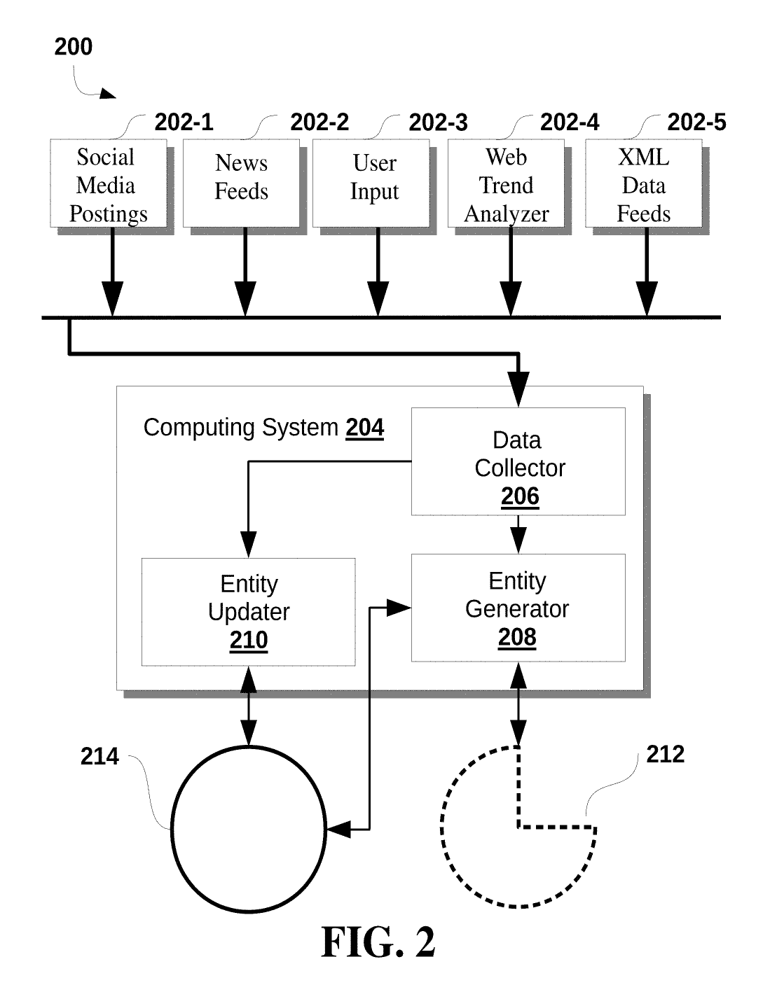

FIG. 2 is a block diagram depicting a system environment 200 for collecting and parsing data for insertion into incomplete virtual entity objects to create unique virtual entities, according to various embodiments.

A computing system 204 receives various data sets from several external sources 202-1 through 202-5 (e.g., the remote data sources 106 of FIG. 1). The external sources may range from online data streams to internal offline data bits, for example, social media postings, XML data feeds, user input, or internal binary data bits. It is to be understood that the external data sources 202 are representative only. Accordingly, more or fewer data sources may be present.

Data is obtained from the data sources 202 and are then input into a data collector module 206 as raw data. The data collector 206 parses and/or modifies the data according to any set of rules, for example, searching for English words for visual colors by comparing a data stream to an internal dictionary file containing Strings for color words and discarding any String data that does not appear in the dictionary file. In another example, as explained above, the data collector may use NLP to analyze and interpret natural language as specified in unstructured data sources (e.g., electronic periodicals, social media posts, emails, etc.)

The data collector 206 passes any information it has received to an entity generator module 208 or an entity updater module 210. Data passed to the entity generator module 208 is used to populate an incomplete virtual entity object 212 if the incomplete virtual entity object 212 has not passed a creation threshold established by the entity generator module 208. Once the creation threshold has been met by the previously incomplete virtual entity object 212, the entity generator module 208 reclassifies the incomplete virtual entity object 212 as a unique virtual entity object 214 and creates a unique virtual entity in a virtual environment, as described in more detail below. For example, the unique virtual entity object 214 in some embodiments is a companion character having at least a NAME, MOOD, VECTOR and DISTANCE attributes. The companion character is designed to interact with a player character using its NAME and responding to the player character according to its MOOD. In some embodiments, if the player character that represents the unique virtual entity moves the specified DISTANCE from the companion character, the companion character will modify its VECTOR to move toward the player character in a “following” pattern.

The entity updater module 210 connects to the unique virtual entity object 214 upon its creation by gaining access to the created instance of the unique virtual entity object or by gaining access to the data location of the unique virtual entity object in memory. The entity updater module 210 may use data passed from the data collector to modify or replace (e.g., insert, delete, etc.) data sets in the unique virtual entity object 214 it has obtained access to.

According to one embodiment, unique virtual entities are created in a virtual environment, but may not be drawn or rendered in the virtual environment. For example, creating a unique virtual entity which corresponds to a unique storyline within a gaming environment may only serve to change the logic of already rendered virtual entities, but to draw the storyline as an object would not be logical within the game setting. For example, rendering an object in a virtual environment like a game may be done independently of the creation of a unique virtual entity in that game environment. A graphics pipeline may be employed to render the vertices of a 3-D object and a unique virtual entity may be insulated from the graphics pipeline by the system to prevent unnecessary and intrusive rendering of an object in the virtual environment.

In some embodiments, a unique virtual entity is generated based on certain characteristics of a user playing a video game. User “characteristics” can be or include mood, personality, occupation, hobbies, name, age, height, gender, ethnicity, etc. of one or more users. In these embodiments, a first video game character that has default attributes/settings (e.g., mood, hair color) can be generated. Then, a set of data is received from the one or more external sources 202 (e.g., social media postings 202-1 and user input 202-3) that is associated with one or more characteristics of one or more users of the video game, such as an entire network of players. Then, the first character can be modified as a background task (e.g., without a user request or specification) based on the one or more characteristics of the users. For example, a network of users can all be baseball players. Accordingly, when the system identifies this, it can modify or change a video game character to be a baseball character or modify the video game in any way that is associated with baseball such as making a baseball field level.

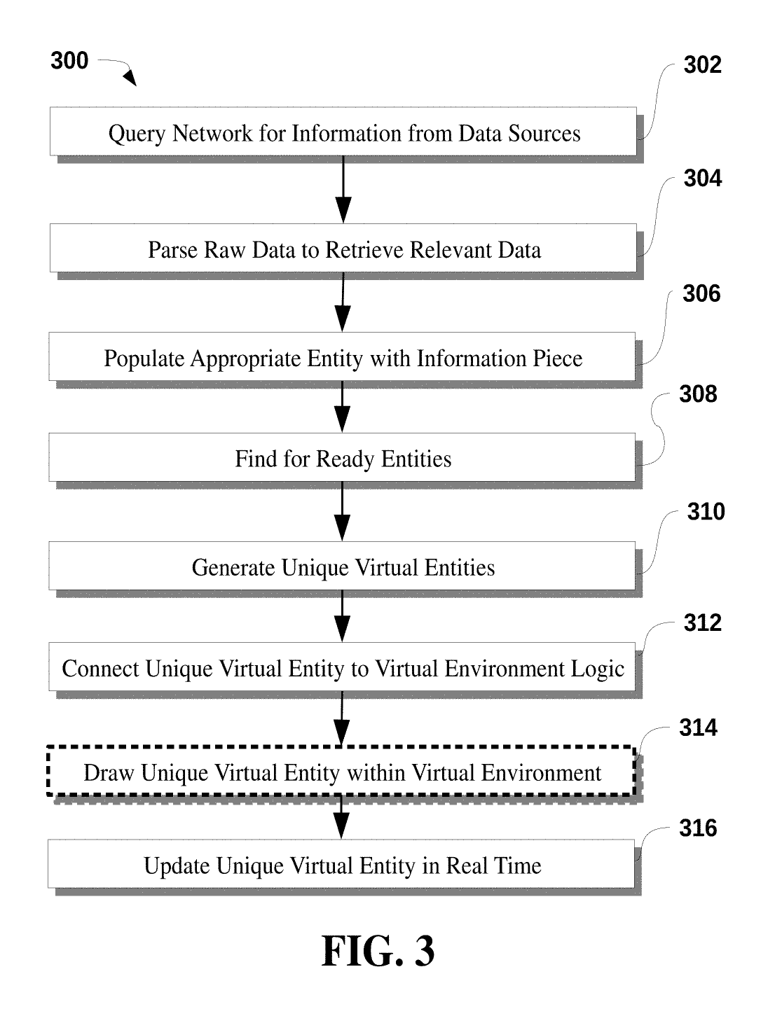

FIG. 3 is a flow diagram depicting a process 300 for retrieving data, populating an incomplete virtual entity object, creating unique virtual entities and modifying a unique virtual entity object, according the various embodiments.

At block 302, the system (e.g., the computer system 104 of FIG. 1) queries a network (e.g., the network 102) or internal memory for data and receives the data relevant to the system task of creating unique virtual entities. Any data may be retrieved by the network or internal memory and passed to the system as a result of this query.

At block 304, the system parses the raw data obtained from the network or internal memory (e.g., via NLP) to obtain concise data sets that may be used to populate the data field of an incomplete virtual entity object.

At block 306, the system populates an incomplete virtual entity object with one or more relevant data sets. The data may be a data set previously parsed and modified by the system, or data from internal memory.

At block 308, the system finds all incomplete virtual entity objects flagged as “ready,” meaning they do not require further data population according to a creation threshold set by the system. The system may query each incomplete virtual entity object in the system to respond to the query with a “ready” signal if all required data fields in the entity have been filled.

In some embodiments, a “ready” signal is a Boolean value where “true” represents the fact that all required data fields have been filled in an incomplete virtual entity object or a primitive numerical value which is compared to a numerical value representing a threshold for how many data fields must be populated before an entity is “ready.”

At block 310, the system generates (e.g., by the entity generator 208 of FIG. 2) unique virtual entities deemed “ready”. The entities may have been very recently been deemed “ready” by the system, or may have been sitting in memory for a longer period of time according to the system's logic of when to signify an incomplete virtual entity object has become a unique virtual entity object.

At block 312, unique virtual entities are connected to the logical process of the virtual environment. The virtual environment may be any virtual representation capable of containing one or more virtual entities, for example, a game environment where multiple unique virtual entities represent characters interacting in an immersive virtual environment. In one instance, a companion character is created and the virtual environment is given access to the instance of the companion character. Alternatively, the virtual environment may store the location of the companion character in memory. The companion character may have locational attributes corresponding to the data fields of LOCATION, VELOCITY, ACCELERATION which were null at the time it was created as an incomplete virtual entity object and were not required to be filled when the entity was deemed to be a unique virtual entity object. The virtual environment may use its new connection to the companion character via the unique virtual entity object to change these data fields (e.g. (0,0,0) for LOCATION to center the character in the virtual world, (0,1,0) for VELOCITY to make the character move forward on a straight plane, and (0,0,−9.8) for ACCELERATION to simulate artificial gravity effect on the character's movement within the environment).

At block 314, unique virtual entities are rendered into the virtual environment, if the virtual environment is represented graphically and the unique virtual entity requires simulative rendering in the environment. Some virtual entities may not require graphical rendering. For example, events and storyline modifiers in a game environment do not require graphical rendering.

At block 316, the unique virtual entity is tethered to the system to update the unique virtual entity object in real time. The entity updater 210 may be checked against a threshold to ensure continued existence of the unique virtual entity in the virtual environment. When the unique virtual entity is not in compliance with the threshold, the unique virtual entity may be deleted or the underlying unique virtual entity object may be modified with additional data sets accordingly. In an illustrative example, the entity updater 210 of FIG. 2 may poll the one or more data sources 106 of FIG. 1 every N quantity of time after a character or other unique virtual entity has been created. The data sources 106 may indicate that some set of attributes have changed between the polling times (e.g., the weather is now 10 degrees colder than the first time it was sampled, or people are not talking about subject X anymore, but instead talking about subject Y on social media). If the change between polling times have exceeded some policy threshold (e.g., a conditional statement reads that if there are less than 20% of all people talking about X in the sampled resources, X attributes will be erased from the virtual game), a corresponding virtual entity is modified (e.g., if X corresponds to a character, and less than 20% of people are referring to that character on social media per the policy threshold, the character may be deleted).

According to various embodiments, the system creating a unique virtual entity checks whether an incomplete virtual entity object exists waiting to be populated with a particular data set. If the system determines that no such incomplete virtual entity object exists it may create one. According to various embodiments, the system creating a unique virtual entity compares an incomplete virtual entity object with a satisfaction threshold in order to determine whether that incomplete virtual entity object may be deemed a unique virtual entity object and created in a virtual environment as a unique virtual entity. For example, the system may require a NAME data field for each unique virtual entity object. Only when the NAME data field is populated in an incomplete virtual entity object is the entity then considered a unique virtual entity object and determined to be ready to be created in the virtual environment as a unique virtual entity.

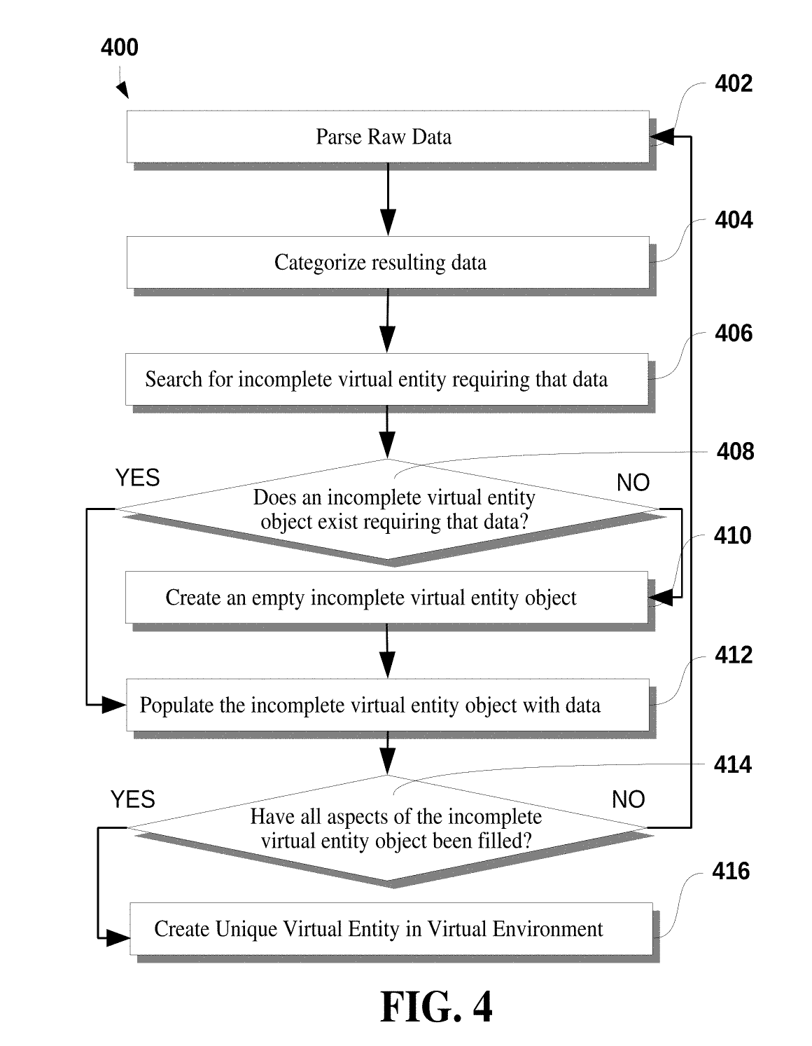

FIG. 4 is a flow diagram depicting a process 400 for the creation and population of incomplete virtual entity objects in order to create unique virtual entities, according to embodiments.

At block 402, raw data is parsed by the system (e.g., by the entity generator 208 of FIG. 2). The system may slice or modify data in any way fit to produce proper data for population of a virtual entity object.

At block 404, the system collects and categorizes the parsed data to determine which data fields the parsed data would fit in categorically. For example, the NLP may use a semantic relationship identifier to identify the token “red” and assign the token a semantic identifier of “color.” In particular embodiments, the semantic identifier is placed as a key value in a map data structure along with the value “red.” Any incomplete virtual entity object requiring a “COLOR” data set in a corresponding data field may be flagged by the system as a potential location for the parsed data.

At block 406, the system prepares at least one parsed and categorized data set for insertion into a virtual entity object by searching for a corresponding virtual entity object which has a data field in the same category as the data set.

At decision block 408, it may be determined whether an instance of an incomplete virtual entity object exists which may have at least one data field categorically corresponding to one data set which is ready to be passed into an incomplete virtual entity object. For example, if the system has flagged an incomplete virtual entity object as requiring a data set of the type “COLOR,” which matches the “color” category determined at block 404, and the data set is mapped with a corresponding key value that is empty, the system may determine that there is at least one instance of an incomplete virtual entity which may accept the data set.

At block 410, in response to the finding that there is no incomplete virtual entity object in existence which may have at least one data field categorically corresponding to one data set which is ready to be passed into an incomplete virtual entity object, the system creates an incomplete virtual entity object having a categorically corresponding data field.

At block 412, in response to the finding that there is an incomplete virtual entity object in existence which may have at least one data field categorically corresponding to one data set which is ready to be passed into an incomplete virtual entity object, the system may populate at least one data field in the incomplete virtual entity with the data set.

At decision block 414, it may be determined whether an incomplete virtual entity object has met a threshold for unique virtual entity creation whereby data sets are no longer required for the incomplete virtual entity object to be considered a unique virtual entity object. If the incomplete virtual entity object has not been filled to meet the threshold, the system may resume actions starting with operation 402. For example, if an incomplete virtual entity object requiring data fields of NAME and COLOR to be considered unique is populated with a data set key-mapped COLOR, but the NAME data field remains null, the system does not create a unique virtual entity and once again queries the network for raw data which may possibly contain a data set corresponding to the NAME data field.

At block 416, in response to the determination that an incomplete virtual entity object has met a threshold for entity creation whereby data sets are no longer required for the entity to be created within a virtual environment, the incomplete virtual entity object is reclassified as a unique virtual entity object and a unique virtual entity is created within the virtual environment.

According to various embodiments, a unique virtual entity object includes several data fields to be filled with data sets before it can be created in a virtual environment. The system may fill any of the incomplete data fields in an incomplete virtual entity object at any time according to any logic. In some embodiments, there is a required data field in each unique virtual entity object, meaning an incomplete virtual entity object can only be created as a unique virtual entity object when all required data fields are populated with data sets. For example, a unique virtual entity may be required by the system to have a NAME and an APPEARANCE, but not a PERSONALITY data filled in order to be created. A unique virtual entity will not be created until both a NAME and an APPEARANCE have been assigned to it by populating those data fields with appropriate data sets in the corresponding virtual entity object. The incomplete virtual entity object may have a PERSONALITY data field filled prior to or after creation, though it may not be necessary at the time of creation.

According to further embodiments, all unique virtual entities created in a virtual environment retain all data fields, empty or not, that were instantiated with the unique virtual entity when it was created from a formerly incomplete virtual entity object. These data fields may be populated with data sets before or after creation in the virtual environment by an entity updater module which may modify the data in required and unrequired data fields as the system sees fit.

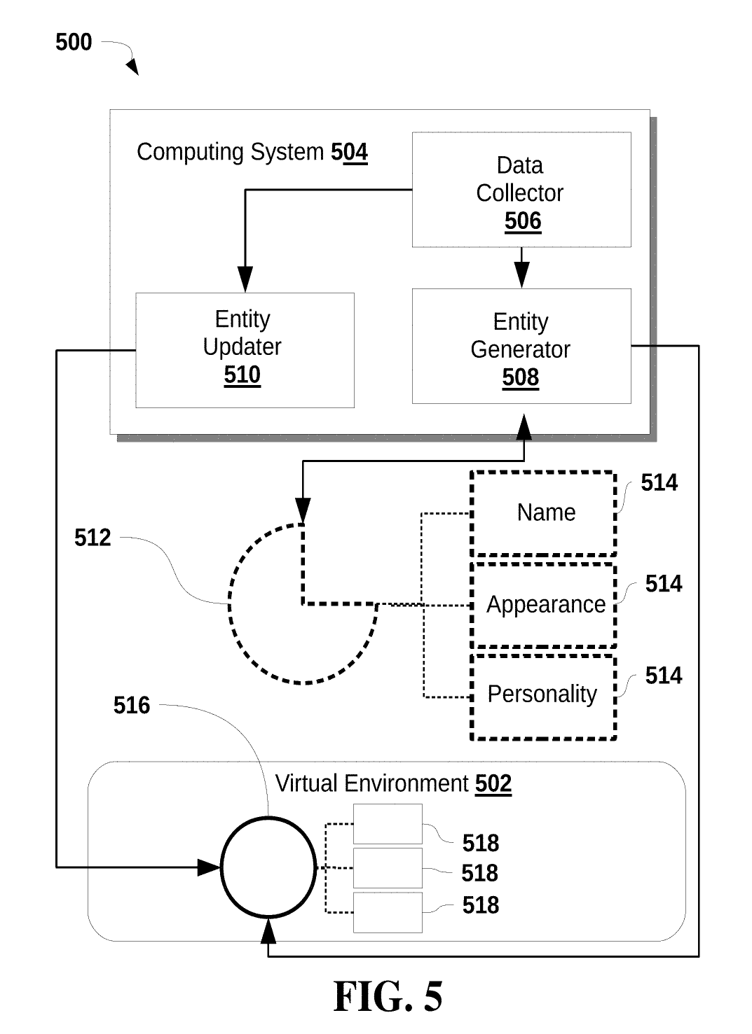

FIG. 5 is a block diagram depicting a system environment 500 in which separate data fields of a virtual entity object are populated using data from various system modules to create a unique virtual entity, according to various embodiments.

The computing system 504 contains modules that pass collected and parsed data from a data collector module 506 to an entity generator module 508 and an entity updater module 510.

The entity generator 508 attempts to pass data sets from the data collector to an incomplete virtual entity object 512. The incomplete virtual entity object may have one or more empty data fields 514 corresponding to some category of data. For example, an incomplete virtual entity object may contain data fields corresponding to a category of NAME, a category of APPEARANCE and a category of PERSONALITY.

The entity generator 508 may only allow the creation of a unique virtual entity 516, having attributes 518 inside of a virtual environment 502 when the corresponding incomplete virtual entity object 512 has enough of its data fields 514 populated with sufficient data to be considered a unique virtual entity object. For example, the entity generator 508 may only allow the creation of a unique virtual entity when the NAME, APPEARANCE, and PERSONALITY data fields of an incomplete virtual entity object have been filled by data sets corresponding to these same categories.

The entity generator 508, may create a unique virtual entity 516 upon the incomplete virtual entity object 512 having passed the threshold test for reassignment to a unique virtual entity object. The unique virtual entity 516 may be created in a virtual environment 502 which may contain any number of other unique and non-unique virtual entities. For example, a unique virtual entity 516 representing a character in a game, having attributes 518 of NAME, APPEARANCE, and PERSONALITY may be created in a game environment containing other unique virtual entities with similar data fields. The game may also include non-unique virtual entities such as characters modeled off of real-world people or locations modeled off of real-world locations.

The entity updater module 510 may interact with the unique virtual entity 516 via its corresponding unique virtual entity object during the course of runtime in the virtual environment 502, by updating or modifying any of its data fields 518 with data sets received form the data collector 506.

According to various embodiments, “machine learning” may be any process in which a computing system “predicts” output values of corresponding input data based on historical and statistical data gleaned from other prior inputs received by the computing system. According to various embodiments, the system receiving data and parsing data may employ machine learning processes to improve efficiency in how data is received or parsed. The system may discard or block data received internally or through the network based on a system of changing thresholds. Such thresholds may correspond to an Interest Level Threshold (ILT) according to various embodiments.

An interest level threshold may be a variable numerical value (e.g., an integer) and/or a Boolean value designed to be measured against some metric of incoming or parsing data. For example, an ILT for a piece of raw data may depend on how many times a person's name is mentioned in a news article which has been collected as a raw text file. In some embodiments, the ILT is determined based on a quantity of string instances of a set of data that match each other. A set of data that “matches” can include words that syntactically and/or semantically match according to semantic similarity. For example, a first person's first name can be recited on a social media post. The same person's last name only can be recited in several news feeds. Further, the same person's pet cat can be mentioned in several blogs. Each of these string instances can be plotted in vector space of a word embedding model (e.g., Word2vec) and it can be determined that all three are within a distance threshold such that they “match” or are semantically similar because they mean the same thing or have the same meaning. Accordingly, the ILT is calculated to be above a threshold based on all three types of these strings instances corresponding to the same person and being recited various times above a threshold. In response to the ILT being above the threshold, the person can be generated as a character in a video game based on all of the matching string instances. In these embodiments, there can be various other subsets of data received from the data sources that do not match (e.g., they are not popular or interesting) and accordingly virtual entities are not generated based on this data.

The ILT may be a floating-point value between the values of 0 and 1.0000000. A parser may increment a floating-point value for each string instance of the name parsed and divide that value by the total number of string instances in the article. An ILT of greater than 0.01 would prevent the reception of an online article containing 5 string instances of a person's name against 600 words (0.01>0.00833333= 5/600). The name ILT would allow data to be sourced from an article containing 10 mentions of a person's name against 100 words (0.01<0.1= 10/100).

According to various embodiments, a threshold metric may be applied to the system employing machine learning processes to create unique virtual entities, by recycling, reusing, and updating the data fields of the underlying unique virtual entities objects in real time. Such thresholds may correspond to an ILT according to various embodiments. For example, a machine learning system can change or add a virtual unique character in a game based on a time of year and/or historical ILT data. In an illustrative example, in the month of December of a first year, the system 108 may query various data sources 106 (e.g., news feeds, social media, posts, etc.) and determine, via NLP, that people are discussing “Santa Clause” over an ILT threshold. The system can associate the time of year with the discussion of Santa Clause. Accordingly, just before December of a second subsequent year, the system can look at historical data including data from December of the first year and responsively generate a Santa Clause character without user interaction or involvement. The generating can further be preceded by identifying sources in the second year that similarly discuss “Santa Clause,” which responsively cause the generation of the character.

According to one further embodiment, the system can use parsed and stored data sets in an entity updater module the update any number of unique virtual entity attributes corresponding to the underlying unique virtual entity objects. For example, the data collection module may parse data for “happy” from a blog posting with the category of MOOD assigned to it, and store that data in an entity updater module as a floating-point value. The entity updater module may check a MOOD data field in each unique virtual entity object at regular intervals and compare it to an ILT. For example, the entity updater module may replace all MOOD data fields not greater than the ILT with a stored value greater than the ILT. All “sad” moods (say all floating-point values less than 0.400000) would be compared with the ILT value for sadness (0.4000000) and all data offending data sets would be replaced with an instance of “happy” MOOD data sets in the entity updater module (greater than 0.6000000).

According to various embodiments, the system may employ machine learning processes to change threshold and testing values to create variable situations in the virtual environment. It is recognized by the present disclosure that the process of creating virtual entities in a virtual environment allows the creation of static characters and environments which do not change appearance, mood or storyline beyond hard-coded parameters set by the writers, artists and programmers. Automating the process of unique virtual entity creation allows for automation of the process of dynamically changing the instances of unique virtual entities which is also a useful and innovative method of game improvement.

According to various embodiments, thresholds used to measure and update data may be modified by the system to add variability to the virtual environment of a game. For example, any ILT used to control the flow of data into a virtual environment through the creation and updating of virtual entities may have its numerical or Boolean values modified by the system employing that ILT.

According to one embodiment, for example, an ILT is being employed to regulate the color of billboards being simulated in a virtual environment. The ILT allows any color with a hex color value corresponding to “blue” greater than 128 (#****80) to be rendered as the background of a billboard. A billboard with a “fuchsia” colored background (#FF00FF) may currently be rendered according to the ILT A rendering module running on the backend of the program constantly tests the average pixel color value being displayed on a user-interactive screen. The rendering module determines the average pixel value being displayed on the screen has a blue hex value exceeding 128 (#****80) which the system deems unacceptable. The system consequently reverses the logic of the ILT for color, by only further allowing the creation of billboards with a blue value less than 128 (#****80). A billboard with a fuchsia colored background is no longer acceptable according to the ILT.

According to one embodiment, for example, an ILT is being employed to choose whether to render a path using stones, dirt, bricks, or asphalt textures. An ILT currently allows all textures to be used. A keylogger module determines that a player character in the game provides 60 percent less keystrokes to a keyboard device when the player character is travelling on a dirt path. Consequently, the system determines that the player character is less interested in dirt paths and signals the ILT to further exclude the creation of dirt paths in the virtual environment.

According to various embodiments, a machine learning system may employ a Bayesian network to determine to proper methods for intake of source data and the creation of unique virtual entities. For example, a machine learning system may predict the probability that a character will be created based on the rate of character creation (C) over time (T) given that a player character is interacting in the world. The probability (P) that a character will be created in a ten second interval within a gaming environment may then correspond to P=(C/T*10IB). Additionally, for example, a NLP may determine that the probability (H) of processing a token containing the adjective “blonde” of data type HAIR COLOR is high due to a saturation of String mentions in an area of the web currently being crawled through.

According to one further embodiment, the machine learning system may employ a Bayesian network to combine the probabilities of (H) and (C/T*10IB) to predict the probability that a blonde character will be created in the next ten seconds. The probability of such an occurrence may be compared to an ILT. If the probability of the creation of a blonde character in the next ten seconds surpasses the ILT, the machine learning system may create a blonde character and in the virtual environment and shift the address of a data crawl to a new area to save time.

According to various embodiments, a machine learning system may modify values of virtual entity objects corresponding to the subclasses of event or storyline objects. A machine learning system may include in each virtual entity object corresponding to an event or storyline object a data field TIMER, for example, which is compared to an ILT. Each event or storyline that a player character interacts with will record to total number of seconds the player character has spent interacting with the event or storyline (S). The machine learning system may divide this number by the total time since the event or storyline object was created (T) to determine an “interaction percentage” (S/T). The machine learning system may keep track of several “interaction percentages” in a database.

In some embodiments, a machine learning system predicts certain characteristics associated with a set of data in order to generate virtual entity object. In these embodiments, a first set of social data is received and compared to a second set of social data that was generated at a time prior to a generation of the first set of social data. A prediction, based on patterns in the second set of social data, that the first set of social data is associated with a first characteristic is made and in response to the prediction at least one unique virtual entity is generated for use in a virtual environment of a virtual game. In an example illustration, the first set of social data received from a news service can include string descriptions of a first famous character. The second set of social data can include both descriptions of the first famous character and a second famous character that is married to the first famous character. The patterns of the second set of data can be found in a linear regression model and/or other vector space associated with neural networks. For example, word vectors associated with the first famous character can be plotted next to the first character in vector space, such as through semantic similarity. When a distance (e.g., Euclidean, Manhattan) is computed from the word vector of the first famous character, to the nearest neighbor word vector, the closest neighbor can be the word vector associated with the second character. The data can be trained to reflect this close distance due to the fact that these two characters are married, if for example, a threshold quantity of news articles talked about their marriage. Accordingly, the “patterns” can include a quantity of time the characters are mentioned together and/or are plotted next to each other in vector space. The predicting that the first set of data (e.g., the first famous character) is associated with the first characteristic can include predicting that the first famous character is still connected or married to the second famous character (e.g., the “first characteristic.”). In response to this prediction, the machine learning system can generate not only the first famous character as a video game character, but the second famous character even though the only data that was received identified the first famous character.

According to one further embodiment, a machine learning system may average the values of the interaction percentages to obtain an Optimal Interaction Time (OIT). The OIT corresponds to the average amount of time a player character spends interacting with an event or storyline object. The machine learning system may modify the data fields through the entity updater module based on data observations with respect to the OIT. For example, the machine learning system may record the average time to complete an event based on all of the event's data fields in the corresponding virtual entity object. If the total time to complete the event is far longer or shorter than the OIT recorded by the system, the data fields in the corresponding virtual entity object may be modified to further conform to the OIT.

According to one further embodiment, a machine learning system tracks gradual changes to the OIT over time to determine whether a change in the behavior of a player character has occurred. Upon finding that a change in the average OIT has occurred, the machine learning system may modify the ILT of various entities in a virtual environment or expand the number of standard deviations that an event's TIMER data field have as a difference from the OIT.

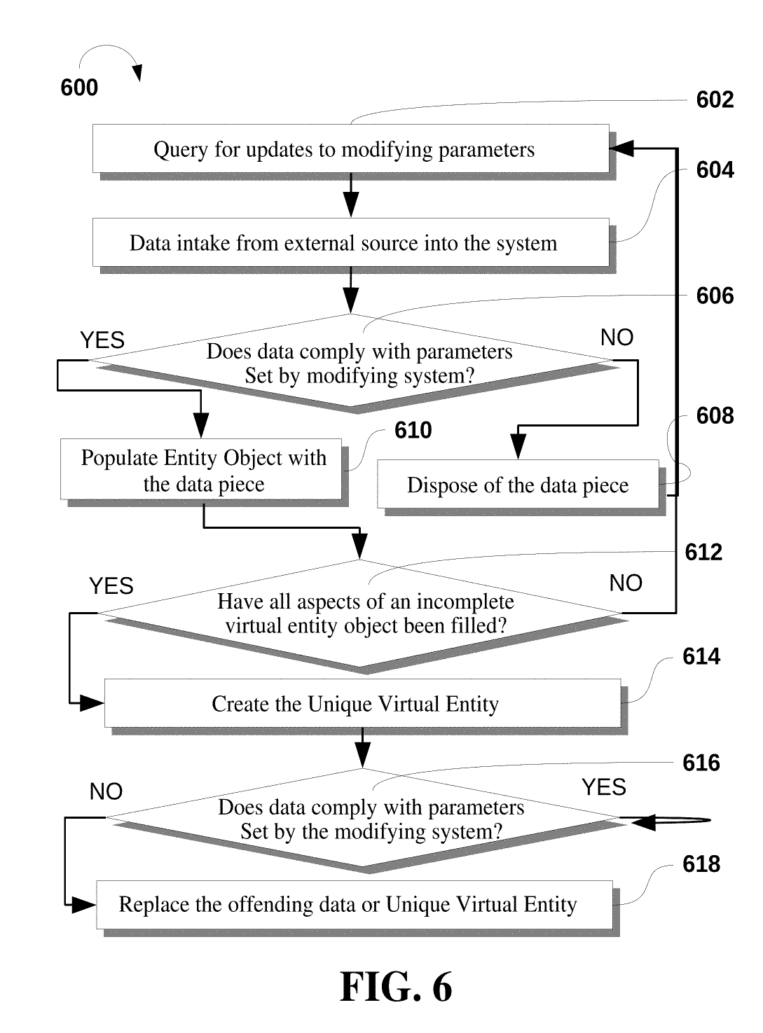

FIG. 6 is a flowchart depicting a process 600 for the modification of data being passed to an incomplete virtual entity object and the modification of unique virtual entities object data fields, according to various embodiments.

At block 604, raw data is taken into the system from external sources and parsed. Relevant slices of data are extracted from the raw data and categorized according to the nature of the data.

At decision block 606, the system checks each data set being readied for insertion into a virtual entity object. A threshold may be used to ensure that compliance with the data sets extracted from the raw data. For example, the system may be programmed to disallow the use of any data in a virtual entity corresponding to a color having a hex value greater than 248 (#F8****) for the RED color component. A slice of data corresponding to the color GREEN (#008000) will be extracted, and allowed to populate a virtual object. A slice of data corresponding to the color YELLOW (#FFFF00) will be extracted and rejected by the system.

At block 608, any data set that is not in compliance with the system threshold may be disposed of through deletion or storage in the system. After disposal, the system returns to block 602, in which the system may check whether any updates to the system threshold have been made before proceeding back to block 604.

At block 610, any data set that is in compliance with the system threshold may be used to populate or modify a virtual entity object, and/or may be held in system memory.

At decision block 612, it may be determined whether an incomplete virtual entity object has met a threshold for unique virtual entity creation whereby the data sets of the incomplete virtual entity are deemed sufficiently populated to reassign the entity as a unique virtual entity object. If no such incomplete entity object is found, the system may resume actions starting with block 602, in which the system may check whether any updates to the system threshold have been made before proceeding back to block 604.

At block 614, if it is determined that an incomplete virtual entity object has met a threshold for entity creation, the incomplete virtual entity is reassigned as unique and a unique virtual entity is created in the virtual environment. The system tracks the unique virtual entity through its lifecycle in the virtual environment and periodically checks the data fields in the underlying unique virtual entity object to ensure compliance with the systems threshold for data.

At decision block 616, it may be determined whether any of the unique virtual entity object data fields are in compliance with the system data thresholds. If all data fields are in compliance, the system may recheck the data periodically at decision block 616.

At block 618, if it is determined that a unique virtual entity object has data fields that no longer comply with the system data thresholds, the unique virtual entity may be deleted from the virtual environment or the offending data field may be repopulated or deleted entirely.

According to one further embodiment, if the machine learning system determines that a unique virtual entity object has data fields that no longer comply with the system data thresholds, such as an ILT for example, the machine learning system may delete the unique virtual entity or repopulate the offending data block. For example, an ILT is used to measure a player characters interest in each object on the users screen. If an object is being rendered by the virtual environment (the object is being drawn by pixels according to logic from a graphics pipeline), each second spent in the player characters lines of sight and rendered (R) may be divided by the total time the player has spent in the game (T). An interest metric could be deduced from the equation R/T which corresponds to a percentage of time the object has been in the players line of sight. An ILT may be compared to the percentage R/T and the corresponding object may be kept in the game or deleted from the game based on whether the percentage R/T is greater than or less than the ILT value.

According to one further embodiment, a machine learning system tracks and stores values for various objects in a game (R1/T, R2/T, R3/T, . . . ) and stores the floating-point percentage values in a data store. The machine learning system may determine patterns of interest by a player character by comparing the attributes of all objects whose on-screen percentage value falls below the ILT set by the system. For example, all on-screen percentage value objects may have a SHIRT COLOR attribute of “red.” The machine may categorize this information and flag “red” as an “uninteresting color.”

According to one further embodiment, the system may determine that “red” is a variable uninteresting to a player character and bar the use of the variable “red” in further virtual entity objects. Additionally, the machine learning system may delete any number of instances of objects having “red” SHIRT COLORS to save processing power in the system.

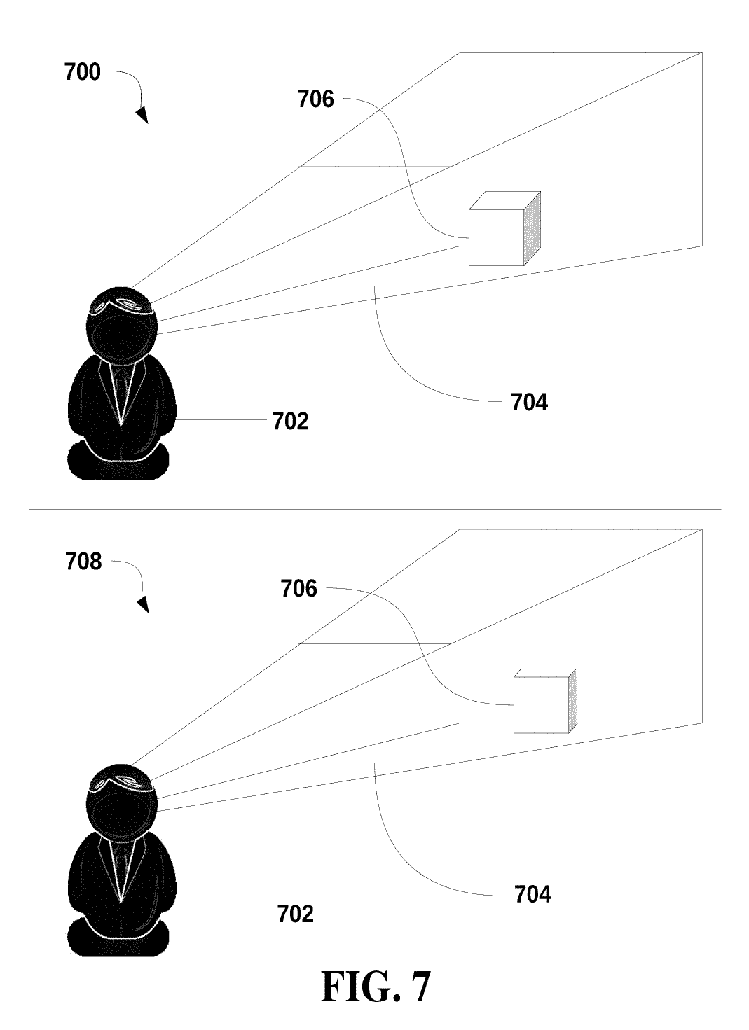

FIG. 7 is a schematic diagram depicting an illustrative virtual environment 700, according to various embodiments.

Many virtual environments involve rendering virtual objects on a user-to-system visual interaction device, such as a screen or monitor. In instances of virtual environments simulating 3-D areas, a first-person camera may be used. This camera corresponds to a viewing frustum 704, which may be shaped as a rectangular pyramid ending at a large square base known as a “far clipping plane.” At the apex of the pyramid is the virtual representation of the user 702 to whom the frustum may be attached. Bisecting the pyramid at any point between the far clipping plane and the virtual representation of the user is a near clipping plane. The volume inside the resulting trapezoidal prism called the “scene” corresponds to the environment in which all objects populating the volume are rendered, or drawn on the user-to-system visual interaction device.

A virtual entity in the scene is visible to a user playing the 3-D game. User immersion in the 3-D game may require new instances of entities in the game to be initially drawn or finally deleted initially at the edges of the scene to prevent characters and object from suddenly rendering or disappearing “out of thin air.” A system creating unique virtual entities may solve this problem by rendering all new unique virtual entities at the near or far clipping planes, or any of the sides of the trapezoidal pyramid.

Illustrative virtual environment 700 depicts a user 702 viewing a rendered entity 706 inside the scene of the viewing frustum 704.

Illustrative virtual environment 708 depicts the same virtual scene at a different time, where the rendered entity 706 has entered the far clipping plane and is subsequently disappearing. Such a method of rendering and retiring character may be one instance in which unique virtual entities can be created and destroyed in a virtual environment.

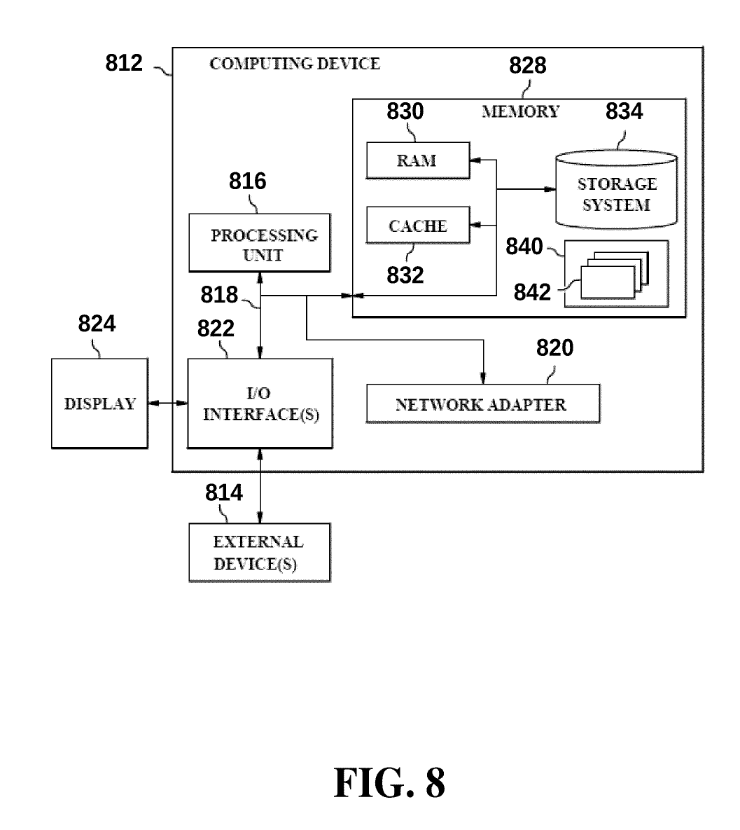

FIG. 8 is a block diagram of a computing device 812, according to embodiments. As shown in FIG. 8, the computing device 812 is shown in the form of a general-purpose computing device, which is not to be construed necessarily by one of ordinary skill in the art as a generic computer that performs generic functions. Rather, the computing device 812 is illustrative only of what components a computing device may include. The components of computing device 812 may include, but are not limited to, one or more processors or processing units 816, a system memory 828, and a bus 818 that couples various system components including system memory 828 to processor 816. In some embodiments, the computing device 812 represents a user device(s), a server(s) or a host device(s).

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 812 typically includes a variety of computer system readable media. Such media may be any available media that is accessible by computing device 812, and it includes both volatile and non-volatile media, removable and non-removable media.

System memory 828 can include computer system readable media in the form of volatile memory, such as random access memory (RAM) 830 and/or cache memory 832. Computing device 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the invention.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein. For example, the program modules 842 may be or include the processes described in FIGS. 1-7.

Computing device 812 may also communicate with one or more external devices 814 such as a keyboard, a pointing device, a display 824, etc.; one or more devices that enable a user to interact with computing device 812; and/or any devices (e.g., network card, modem, etc.) that enable computing device 812 to communicate with one or more other computing devices. Such communication can occur via Input/Output (I/O) interfaces 822. Still yet, computing device 812 can communicate with one or more networks such as a local area network (LAN), a general wide area network (WAN), and/or a public network (e.g., the Internet) via network adapter 820. As depicted, network adapter 820 communicates with the other components of computing device 812 via bus 818. It should be understood that although not shown, other hardware and/or software components could be used in conjunction with computing device 812. Examples, include, but are not limited to: microcode, device drivers, redundant processing units, external disk drive arrays, RAID systems, tape drives, and data archival storage systems, etc.

Aspects of the present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The following definitions are specific to this disclosure:

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

The term “real time” includes any time frame of sufficiently short duration as to provide reasonable response time for information processing as described. Additionally, the term “real time” includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

The term “causing” or “cause” means that one or more systems (e.g., computing devices) and/or components (e.g., processors) may in in isolation or in combination with other systems and/or components bring about or help bring about a particular result or effect. For example, a server computing device may “cause” a message to be displayed to a user device (e.g., via transmitting a message to the user device) and/or the same user device may “cause” the same message to be displayed (e.g., via a processor that executes instructions and data in a display memory of the user device). Accordingly, one or both systems may in isolation or together “cause” the effect of displaying a message.

The term “computing system” means a single computing device (e.g., a mobile device) and/or multiple computing devices (e.g., multiple cloud computing nodes).

The terms first (e.g., first cache), second (e.g., second cache), etc. are not to be construed as denoting or implying order or time sequences. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

What is claimed is:

1. A computer-implemented method comprising:
receiving, over at least one wireless network and from one or more sources, a set of data associated with one or more real world conditions;
determining, based at least on a quantity of string instances of the set of data that match each other, that a first subset of the set of data surpasses an interest level threshold, wherein a second subset of the set of data does not surpass the interest level threshold;
generating, based on the first subset of data surpassing the interest level threshold, at least one unique virtual entity for use in a virtual environment of a virtual game.

2. The method of claim 1, further comprising generating a first unique virtual entity for the virtual game, wherein the first unique virtual entity includes attributes derived from at least a first source of a group of sources consisting of: a social media service, a news service, a blog posting, an XML data feed, and a user's mobile device.

3. The method of claim 1, further comprising generating, based on the determining that the first subset of the set of data surpasses an interest level threshold, a video game character and a video game story line of the virtual game.

4. The method of claim 1, further comprising adjusting, based on the determining, a virtual entity object corresponding to a video game character, the adjusting includes changing one or values of one or more attributes consisting of: name, age, height, gender, personality, and mood of the video game character.

5. The method of claim 1, further comprising adjusting, based on the determining, a virtual entity object corresponding to a storyline, the adjusting includes reducing or adding one or more levels to the virtual game, wherein the adjusting is further based on analyzing the set of data associated with the one or more real world conditions.

6. The method of claim 1, further comprising:
deleting the unique virtual entity from the virtual environment in response to the set of data no longer meeting the interest level threshold; and
recycling the set of data used to generate the unique virtual entity, wherein the set of data is reused in a different unique virtual entity at another time.

7. The method of claim 1, further comprising:
receiving, from the one or more sources, a second set of data associated with another set of real world conditions;
determining, based at least on a second quantity of string instances of the second set of data that match each other, that a third subset of the second set of data surpasses the interest level threshold, wherein the first subset of data no longer surpasses the interest level threshold;
changing, without a user request and based on the determining that the third subset of the second set of data surpasses the interest level threshold and the first subset of data no longer surpasses the interest level threshold, one or more attributes of the at least one unique virtual entity.

8. A system comprising:
at least one computing device having at least one processor; and
at least one computer readable storage medium having program instructions embodied therewith, the program instructions readable or executable by the at least one processor to cause the system to:
receive, from one or more sources, a first set of social data;
compare the first set of social data to a second set of social data that was generated at a time prior to a generation of the first set of social data;
predict, based on patterns associated with the second set of social data, that the first set of social data is associated with a first characteristic; and
generate, in response to the predicting, at least one unique virtual entity for use in a virtual environment of a virtual game.

9. The system of claim 8, wherein the program instructions further cause the system to generate a first unique virtual entity for the virtual game, wherein the first unique virtual entity includes attributes derived from a group of sources that include: a social media service, a news service, a blog posting, an XML data feed, and a user's mobile device.

10. The system of claim 8, wherein the program instructions further cause the system to generate, based on the predicting that the first set of social data is associated with a first characteristic, a video game character and a video game story line of the virtual game.

11. The system of claim 8, wherein the program instructions further cause the system to adjust, based on the predicting that the first set of social data is associated with the first characteristic, a virtual entity object corresponding to a video game character, the adjusting includes changing one or values of one or more attributes consisting of: name, age, height, gender, personality, and mood of the video game character.

12. The system of claim 8, wherein the program instructions further cause the system to adjust, based on the predicting, a virtual entity object corresponding to a storyline, the adjusting includes changing a plot to the virtual game.

13. The system of claim 8, wherein the program instructions further cause the system to:
delete the unique virtual entity from the virtual environment in response to the first set of data no longer being associated with the first characteristic; and
recycling the first set of data used to generate the unique virtual entity, wherein the first set of data is reused in a different unique virtual entity at another time.

14. The system of claim 8, wherein the program instructions further cause the system to:
receive, from the one or more sources, a third set of social data;
compare the third set of social data to the first set of social data and the second set of social data;
predict, based on patterns associated with the first set of social data, that the third set of social data is not associated with the first characteristic; and
changing, without a user request and based on the predicting that the third set of social data is not associated with the first characteristic, one or more attributes of the at least one unique virtual entity.

15. A computer program product, the computer program product comprising a computer readable storage medium having program instructions embodied therewith, the program instructions readable or executable by a computing system to cause the computing system to:
generate at least one virtual entity for use in a virtual environment of a virtual game;
receive, from one or more sources, a set of data associated with one or more characteristics of one or more users of the virtual game; and
modify, as a background task and based on the one or more characteristics of the one or more users, the at least one unique virtual entity.

16. The computer program product of claim 15, wherein the program instructions further cause the computing system to generate a first unique virtual entity for the virtual game, wherein the first unique virtual entity includes attributes derived from at least a first source of a group of sources consisting of: a social media service, a news service, a blog posting, an XML data feed, and a user's mobile device.

17. The computer program product of claim 15, wherein the program instructions further cause the computing system to generate, based on the one or more characteristics of the one or more users of the virtual game, a video game character and a video game story line of the virtual game.

18. The computer program product of claim 15, wherein the program instructions further cause the computing system to adjust, based on the one or more characteristics of the one or more users changing, a virtual entity object corresponding to a video game character, the adjusting includes changing each attribute consisting of: name, age, height, gender, personality, and mood of the video game character.

19. The computer program product of claim 15, wherein the program instructions further cause the computing system to adjust, based on the characteristics of the one or more users changing, a virtual entity object corresponding to a storyline, the adjusting includes reducing or adding one or more features to one or more levels to the virtual game.

20. The computer program product of claim 15, wherein the program instructions further cause the computing system to:
delete the unique virtual entity from the virtual environment in response to determining that the one or more characteristics of the one or more users has changed; and
recycling the set of data used to generate the unique virtual entity, wherein the set of data is reused in a different unique virtual entity at another time based on machine learning.
